(19) United States
(12) Patent Application Publication
(10) Pub. No.: US 2019/0026770 A1
(43) Pub. Date: Jan. 24, 2019

(54) SYSTEMS AND METHODS FOR PRICING COMBINATIONS OF ITEMS

(71) Applicant: Walmart Apollo, LLC, Bentonville, AR (US)

(72) Inventors: Ramprabhu Murugesan, Coimbatore (IN); Kedaranath Bhat, Uttar Kannada (IN); Sumit Goel, Yamuna Nagar (IN)

(21) Appl. No.: 16/038,663

(22) Filed: Jul. 18, 2018

Related U.S. Application Data
(60) Provisional application No. 62/533,958, filed on Jul. 18, 2017.
(60) Provisional application No. 62/533,938, filed on Jul. 18, 2017.

(51) Int. Cl. G06Q 30/02; G06Q 30/06; G06Q 10/08

(52) U.S. Cl. CPC G06Q 30/0238; G06Q 10/087; G06Q 10/0833; G06Q 30/0641

(57) ABSTRACT

Embodiments described herein relate to technological improvements over existing, manual pricing modification for combinations of items. Systems and methods maintain advertized discounts, promotions, or sales even when some of a requested item is substituted or eliminated from a customer's order.

### RELATED APPLICATIONS

The present application claims the benefit of U.S. Provisional Application No. 62/533,938 filed Jul. 18, 2017, and U.S. Provisional Application No. 62/533,958 filed Jul. 18, 2017, the disclosures of which are hereby incorporated by reference in their entireties.

### TECHNICAL FIELD

Embodiments described herein relate to specific computational models, including digital computing or data processing equipment and methods specially adapted for the function of ensuring that advertized discounts, promotions, or sales are maintained even when some of a requested item is substituted or eliminated from a customer's order or advertised promotions are expired.

### BACKGROUND

Online ordering of goods can be convenient for both retailers and consumers. Retailers can distribute items from a warehouse or other central storage facility and need not maintain as much retail floor space. Customers benefit from increased convenience of an item arriving at a desired location at a desired time.

In a conventional online ordering fulfillment system, an order is received at a fulfillment center and sent to a “picker,” which can be a person or robot tasked with locating and compiling all of the items requested in the order. A picker has some autonomy in replacing ordered items with appropriate substitutes at times when stock of the ordered item runs low. If an item that was ordered is out of stock, the picker can elect to fulfill the order with a similar or equivalent item (“substitution”). Alternatively, if the picker does not find any similar or equivalent, the picker can note that the item could not be shipped (referred to as a “nil pick”).

For many consumer goods, prices remain relatively stable over weeks, months, or even years. Other items, including groceries, can vary in price significantly over a relatively short period of time. In some cases, perishable items can have significantly lower prices when there is a large supply of that item, to ensure that the entire supply is sold while it is still fresh. In contrast, where supply of a perishable item is very low, the price can be higher. Over a time period, such as a course of several weeks, the price of such items can fluctuate by a significant amount based on the availability of the item.

Likewise, the price of seasonal items can fluctuate, or manufacturers or retailers can create an incentive to purchase an item or set of items in larger quantities. Such discounts can be monitored by the retailer as “linksave.” For example, retailers can offer an item as “two-for-one,” a percentage discount, or a flat discount associated with the purchase of a combination of items.

The combination of these types of discounts with online ordering creates a logistical challenge for retailers. In the event that a substitution is made, the retailer must decide what price to assign to the substituted item. In some cases, the substituted item can be more or less expensive than the originally-ordered item. In other cases, the substituted item and the originally-ordered item can fluctuate in price sufficiently that the former was more expensive at the time of order and has become less expensive by the time the order was fulfilled (or vice versa). In many instances, there will be a time delay of several hours or even days between the time that an order is placed and the time it is fulfilled. This can present an additional challenge for a retailer if a linksave item is substituted or nil picked after a particular promotion has expired. In some cases, a substitution is not even possible and a nil pick occurs. In those circumstances, the retailer must determine what discount, if any, the customer is entitled to if the nil pick results in the conditions of the order not being met at the time of fulfillment.

Likewise, for linksave items or items with bulk discounts, the fulfilled order may not qualify for a discount even though the original order qualified. This creates challenges for the retailer, who must decide whether to honor the original discount, not honor the original discount, or provide some other discount that will be acceptable to the customer and also not onerous to the retailer.

Conventionally, price adjustment decisions have made manually, and often at the discretion of an employee who is authorized to make price modification decisions. This can result in inconsistency, especially where a customer must communicate directly with an employee in order to request a discount.

### SUMMARY

According to an embodiment, a system includes an ordering interface configured to receive an order for the set of items from a customer. The system further includes a fulfillment device configured to receive the order for the set of items from the ordering interface. The fulfillment device is configured to monitor a fulfilled set of items that are selected for shipment to the customer. The system includes an analytical engine communicatively coupled with the fulfillment device to calculate a price for the fulfilled set of items. The analytical engine includes an item comparison module configured to compare the set of items with an inventory of discounts and promotions to generate linksaves. A replacement identification module is configured to compare the set of items with the fulfilled set of items to determine a quantity of nil picks and a quantity of substitutions for each item of the set of items. A categorization module is configured to categorize the linksaves and associate each of the fulfilled items, the nil picks, and the substitutions with a corresponding linksave. A plurality of linksave modules are each associated with a category of linksave, and each of the linksave modules are configured to calculate a subtotal price for each of the fulfilled set of items. A summing module is configured to receive the subtotal prices for each of the fulfilled set of items and generate a price.

In some embodiments, the fulfillment device can be configured for the picker to indicate what products have been selected so that the analytical engine can determine whether a substitution or a nil pick has been made.

In embodiments, the fulfillment device is configured to suggest one or more substitutions. The discount types can include at least some of the fulfilled set of items being multiples of a same item at a bulk price.

At least some of the fulfilled set of items can be multiples of a same item at a bulk price, and others of the fulfilled set of items can be substitutes for the same item. At least some of the fulfilled set of items can be a grouping of multiple items at a grouped price. At least some of the fulfilled set of items can be assigned a percent discount. At least some of the fulfilled set of items can be multiples of a same item associated with a flat discount amount. The analytical engine can be configured to apply the discount types in order: first, discounts corresponding to at least some of the fulfilled set of items being multiples of a same item at a bulk price; then discounts corresponding to at least some of the fulfilled set of items being multiples of a same item at a bulk price, and others of the fulfilled set of items being substitutes for the same item; then discounts corresponding to at least some of the fulfilled set of items being a grouping of multiple items at a grouped price; then discounts corresponding to at least some of the fulfilled set of items being assigned a percent discount; and then discounts corresponding to at least some of the fulfilled set of items being multiples of a same item associated with a flat discount amount.

In embodiments, the system includes a tax module configured to apply a tax to the price produced by the analytical engine.

In embodiments, a linksave identification module is configured to compare the fulfilled set of items to the ordered set of items and generate a list of linksaves that were applicable at the time when the order was placed at the ordering interface. The system can be configured to apply any linksaves that were applicable at the time the order was placed in order to determine the price despite an indication from the fulfillment device of a substitution or a nil pick.

In embodiments, a point of sale is communicatively coupled to the analytical engine and the fulfillment device and is configured to receive the price of the fulfilled set of items from the analytical engine, receive a payment for the price of the fulfilled set of items from the customer; and to instruct the fulfillment device to release the fulfilled set of items for delivery to the customer.

According to another embodiment, a method includes acquiring an order for a set of items from a customer via an order interface, sending the order from the order interface to a fulfillment device, fulfilling the order using the fulfillment device and tracking a fulfilled set of items that are selected for shipment to the customer, and calculating, at an analytical engine, a price for the fulfilled set of items. The analytical engine includes a comparator module configured to compare the set of items with the fulfilled set of items, a counter module configured to determine a quantity of nil picks and a quantity of substitutions for each of the set of items, a plurality of linksave modules each associated with one of a corresponding plurality of discount types and configured to calculate a subtotal price for each of the fulfilled set of items, and a summing module configured to receive the subtotal prices for each of the fulfilled set of items and generate a price.

In some embodiments, the method includes replacing one of the set of items with a substitution, wherein the substitution is selected from a similar item or a nil pick.

In embodiments, the method includes sending an indication of the substitution or the nil pick from the fulfillment device to the analytical engine.

In embodiments, the method includes sending one or more suggestions for a substitution from the analytical engine to the fulfillment device.

In embodiments, the discount types of the method include: at least some of the fulfilled set of items being multiples of a same item at a bulk price; at least some of the fulfilled set of items being multiples of a same item at a bulk price, and others of the fulfilled set of items being substitutes for the same item; at least some of the fulfilled set of items being a grouping of multiple items at a grouped price; at least some of the fulfilled set of items being assigned a percent discount; and at least some of the fulfilled set of items being multiples of a same item associated with a flat discount amount. The analytical engine can be configured to apply the discount types in the following order: at least some of the fulfilled set of items being multiples of a same item at a bulk price; then at least some of the fulfilled set of items being multiples of a same item at a bulk price, and others of the fulfilled set of items being substitutes for the same item; then at least some of the fulfilled set of items being a grouping of multiple items at a grouped price; then at least some of the fulfilled set of items being assigned a percent discount; and then at least some of the fulfilled set of items being multiples of a same item associated with a flat discount amount.

In embodiments, the method can include determining at the analytical engine a price of non-discrete items.

In embodiments, the method can include applying a tax to the price produced by the analytical engine via a tax module.

In embodiments, the method can include comparing the fulfilled set of items to the ordered set of items and generating a list of linksaves that were applicable at the time when the order was placed at the ordering interface.

In embodiments, the method can include applying any linksaves that were applicable at the time the order was placed in order to determine the price despite an indication from the fulfillment device of a substitution or a nil pick.

### BRIEF DESCRIPTION OF THE DRAWINGS

Subject matter hereof may be more completely understood in consideration of the following detailed description of various embodiments in connection with the accompanying figures, in which:

FIG. 1 is a simplified schematic of a pricing modification system according to an embodiment.

FIG. 2 is a flowchart of an ordered subsystem of linksaves that make up a linksave loop according to an embodiment.

FIG. 3A is a flowchart of a method for pricing linksaves associated with multiple-item discounts according to an embodiment.

FIG. 3B is a flowchart of a method for pricing linksaves associated with combination-based discounts according to an embodiment.

FIG. 3C is a flowchart of a method for pricing linksaves associated with percentage-based discounts according to an embodiment.

FIG. 4 is a perspective view of a picking device according to an embodiment.

While various embodiments are amenable to various modifications and alternative forms, specifics thereof have been shown by way of example in the drawings and will be described in detail. It should be understood, however, that the intention is not to limit the claimed embodiments to those embodiments described in detail below with respect to the claims. On the contrary, the intention is to cover all modifications, equivalents, and alternatives falling within the spirit and scope of the subject matter as defined by the claims.

### DETAILED DESCRIPTION OF THE DRAWINGS

Embodiments described herein relate to technological improvements over existing, manual pricing modification for combinations of items. The disclosed embodiments provide a systematic automation of the previously manual and arbitrary process of price adjustment for fulfilled orders, and a number of improvements to conventional order fulfillment systems.

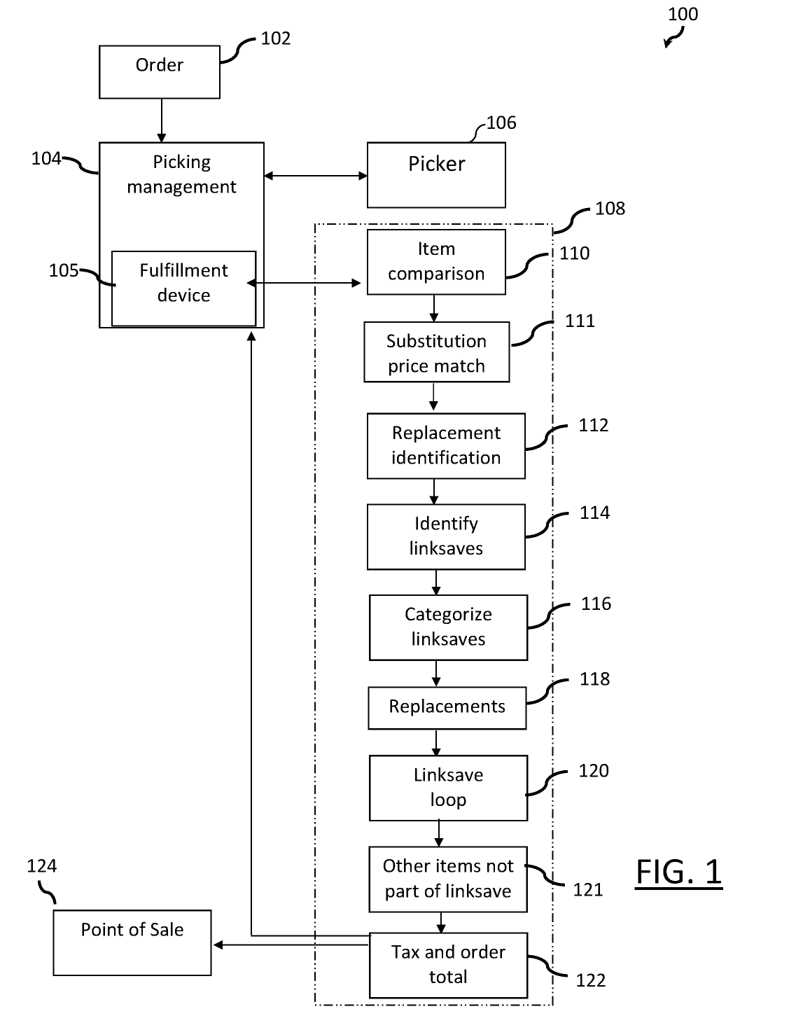

FIG. 1 is a schematic of a system 100 for improved pricing modification on combinations of items. System 100 receives an order 102, which can be an online order, a telephone order, or some similar request from a customer. Order 102 can be an order for delivery to a residence or business, or in embodiments order 102 can be placed for in-store pickup. Order 102 can be received from a customer by an ordering interface such as a website, app, telephonic ordering system, or other communicative interface for receiving an order for a set of items from a customer.

Order 102 is forwarded to picking management subsystem 104. Picking management subsystem 104 can include a variety of mechanical and/or electronic components, referred to as fulfillment devices 105. Picking management 104 can send instructions to fulfillment devices 105 including what items are needed and what orders 102 those items are needed for. Picking management subsystem 104 communicatively interacts with analytical engine 108 via a fulfillment device 105 and a picker 106 to manage each order 102.

In some embodiments, each of the fulfillment devices 105 is a handheld device used by an individual, referred to as a picker 106, who acquires the set of items identified in each order 102 and compiles those items for delivery or for pickup by the customer. In other embodiments, some or all of the picking can be conducted mechanically, such as by using conveying devices, scanning devices, and/or geolocation devices to locate and transport the items in each order to a location where they can be shipped or picked up by the customer. In those embodiments, picker 106 can be a robot or other device that can locate the items within a particular order 102. In embodiments, multiple fulfillment devices can interact with picking management 104 and/or with one another in coordination to select the items corresponding to an order 102.

Picking management 104 can manage modifications to the original order 102. In some instances, an item that is among the set of items in an order 102 is out of stock, or is in low supply, or cannot be delivered for some other reason. A picker 106 can opt to replace an individual item with a replacement that is considered to be a suitable substitute, either with or without instructions from picking management 104. In embodiments, a picker 106 can indicate to picking management 104 via a handheld device, or enter in a fulfillment device 105 that a substitution has been made, or in some other way notify the picking management 104 subsystem that the ordered item will not be delivered but that some alternative is being delivered instead.

Analytical engine 108 includes a series of modules. Item comparison module 110 compares the set of items of the order 102 with a listing of available discounts and promotions. This comparison is conducted based upon the time that the order 102 was placed, rather than at the time of fulfillment.

Substitution price match module 111 can determine the price of the substituted items and compares those prices to the originally-ordered item. If the originally-ordered item is more expensive than the substituted item, then analytical engine 108 will use the price of the substituted item in subsequent steps. If the substituted item is more expensive then the originally-ordered item, then analytical engine 108 will use the price of the originally-ordered item in subsequent steps.

Next, at replacement identification module 112, the order 102 is compared to the set of items compiled by picker 106. In some cases, as described above, an ordered item has been replaced by a suitable alternative. These replacement items are expressly defined as a “substitution” or “substituted item” for purposes of this disclosure. Although the item may be acceptable to the customer, often a substitution has a different price from the original item. For many types of discounts, this price difference can create difficulty because either the customer will end up paying for more than he or she was expecting, or alternatively if the retailer does not increase the price of the overall order when a substitution for a more expensive item is made then the retailer may end up with significant losses.

Furthermore, some items in the order 102 cannot be fulfilled or substituted. Rather, in some cases picker 106 can indicate that the item is not available and will not be a part of the shipped order. This unfulfilled item order is expressly defined as a “nil pick” for purposes of this patent application.

An identify linksaves module 114 identifies any linksaves that were present in the original order 102. Furthermore, identify linksaves module 114 associates the fulfilled items (including substituted items and nil picks) with the identified linksaves.

After the ordered items are compared to the fulfilled items, a categorize linksave module 116 associates each of the fulfilled items, nil picks, and substitutions with a corresponding linksave. A “linksave” is hereby expressly defined for purposes of the disclosure as a set of ordered items and an associated discount. As described in more detail below, examples of linksaves include promotions for orders of multiple units of the same item. Other linksaves can include promotions for orders of combinations of different items. Linksaves can be for a flat dollar amount discount, or for a percentage discount, or a flat price for a set of items, for example. Linksaves are based upon the items present in the order 102, rather than the fulfilled items. A linksave is so called because where a customer is entitled to savings at the time of order, the discount should not be “broken” because a picker 106 has elected to perform a substitution for an item that does not qualify for the promotion, nor should the discount be “broken” due to a nil pick. A linksave persists even where an item is substituted or not picked at all (nil picked). The linksave refers to the original combination that qualifies for an advertized discount or promotion, and can be associated with any combination of fulfilled items, substituted items, or nil picks. Other items that are not a part of any discount or promotion group can be included in an order and are not linksave items. Additionally, some items in an order may not be a part of a linksave as originally ordered. When items are substituted or nil picked at fulfillment, however, some originally-ordered items may become a part of the linksave group.

Analytical engine 108 further includes a replacements module 118 that associates each of the substitutions and nil picks with the linksaves, even where the original order has been modified and the terms of the promotion are not met by the fulfilled order.

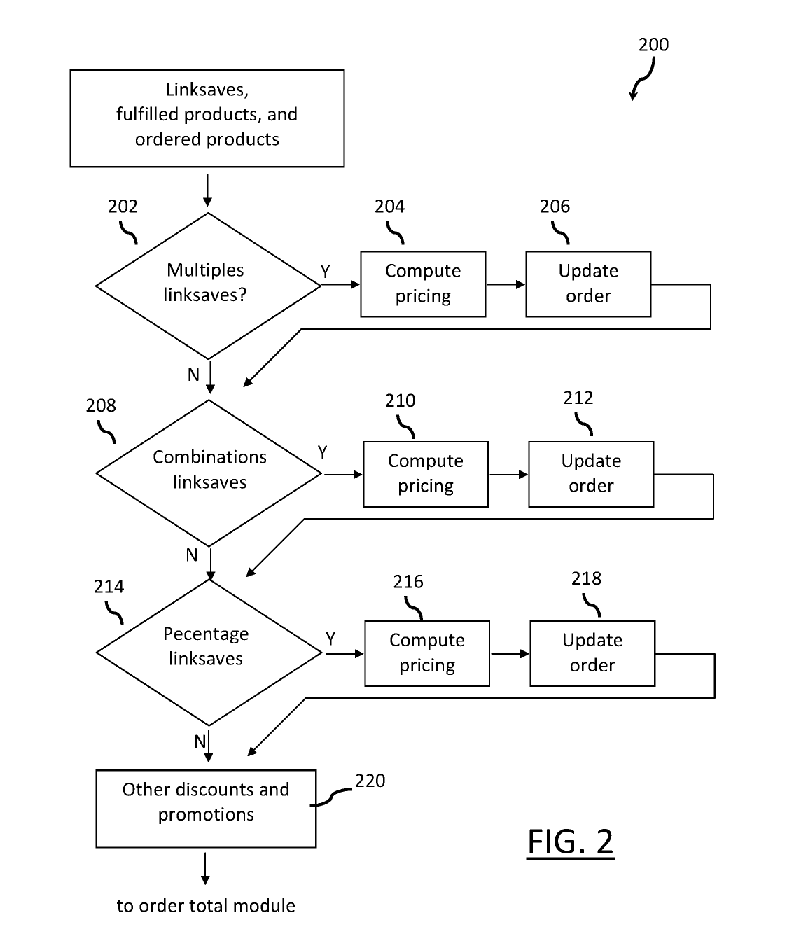

Linksave loop 120 can include a plurality of modules, each associated with a particular type of linksave, as described in more detail with respect to FIG. 2. Each of the modules can create a subtotal price and savings corresponding to the particular items that are grouped together and associated with a particular linksave.

At module 121, items that are fulfilled that are not associated with any linksave group are added to the order total.

By summing these subtotals from the linksave loop 120, as well as the list prices of any items within order 102 that were not associated with any linksaves, order total module 122 can determine the amount due for the order 102. The order total calculated by order total module 122 can also include taxes, fees, or other modifications that can vary by location. The order total is communicated from order total module 122 to point of sale 124, (or “POS”).

Point of sale 124 can be configured to facilitate payment for the transaction, and authorize the picked items for release to the customer, for example, for shipment or in-store pickup. Point of sale 124 can comprise a cash register, scanner, computer, tablet, or other devices used at cash wrap, checkout areas, or fulfillment areas to tally and record customer purchases, accept payment and handle returns or other customer transactions. Point of sale 124 can therefore record transaction logs of the various purchases. In an embodiment, a customer membership card associated with the retail environment can be interfaced with point of sale 124.

FIG. 2 is a more detailed flowchart of one method 200 that can be implemented as a linksave loop 120 of FIG. 1. Method 200 determines the manner that any linksaves created in the original order (e.g., order 102 of FIG. 1) should be factored into a final price for a fulfilled set of items. Method 200 can be implemented at a linksave loop module (e.g., linksave loop 120 of FIG. 1) that receives inputs from other modules within an analytical engine (e.g., analytical engine 108 of FIG. 1). These inputs include identified linksaves (e.g., linksaves identified at linksave identification module 114 of FIG. 1), as well as the item comparison (e.g., from item comparison module 110 of FIG. 1) and any replacements of items made by a picker (e.g., from replacement identification module 112 of FIG. 1). Method 200 then applies the linksaves in a specified order (e.g., the order specified by linksave categorization module 116 of FIG. 1).

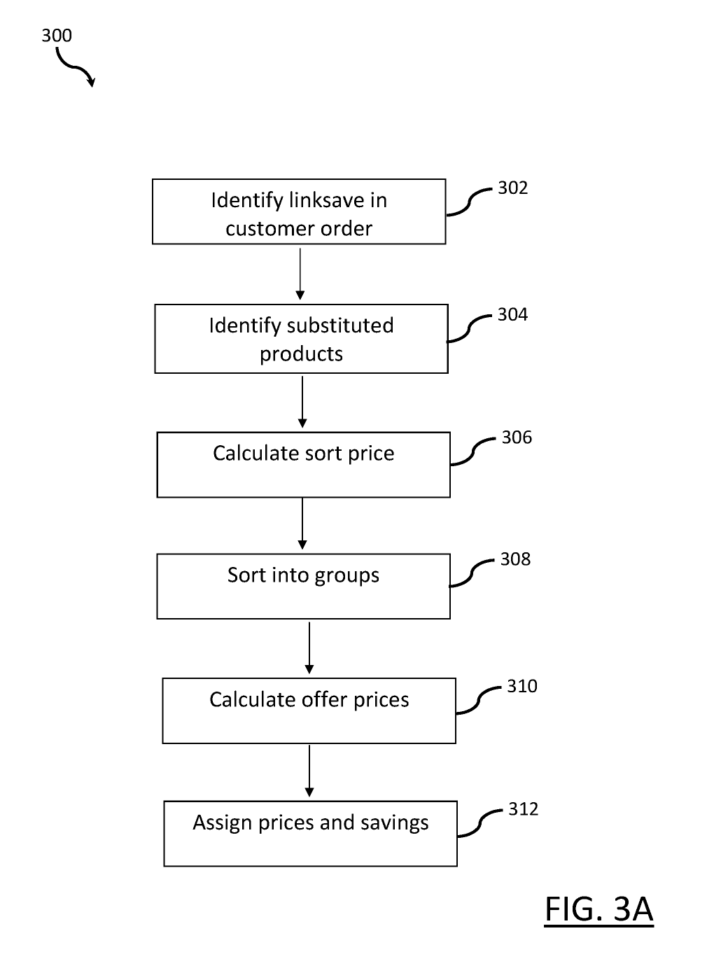

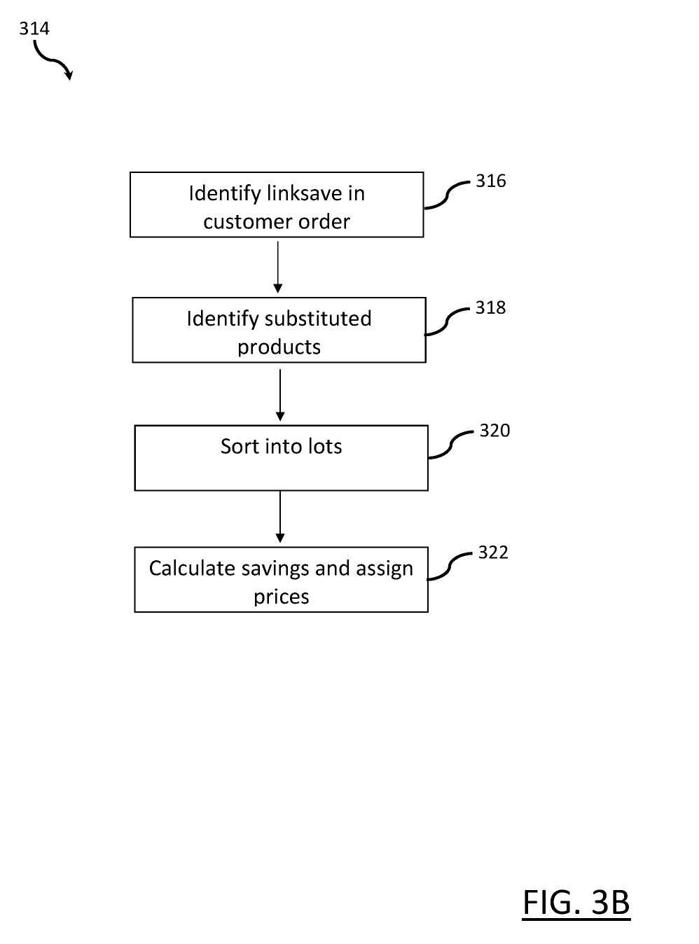

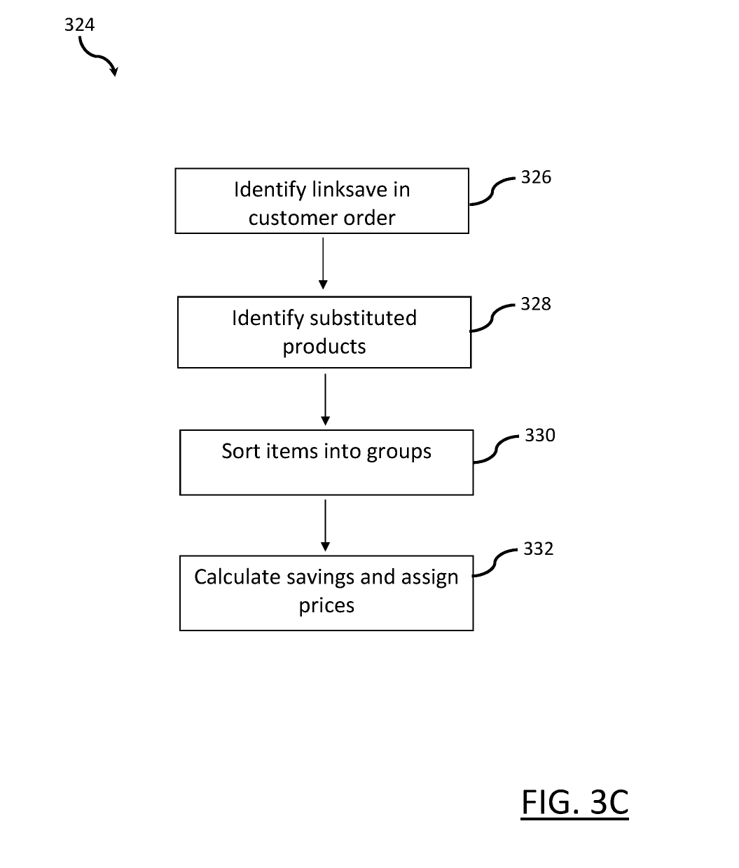

At 202, method 200 includes determining whether any “multiples” linksaves exist. Multiples linksaves correspond to items that are available in a group for some specified discount. In the event that at least one multiples linksave was identified (e.g., by linksave identification module 114 of FIG. 1), pricing is determined for each of the linksaves at 204. Once pricing is computed, the order is updated at 206. More details and several examples of computing the pricing at 204 and updating the order at 206 for multiples linksaves are described with respect to FIG. 3A, below.

Once all multiples linksaves have been addressed, or in the event that no multiples linksaves were present in the original order, method 200 addresses combination linksaves at 208. Combination linksaves correspond to distinct items that are available in combination with one another in a group for some specified discount. In the event that at least one combination linksave was identified (e.g., by linksave identification module 114 of FIG. 1), pricing is determined for each of the linksaves at 210. Once pricing is computed, the order is updated at 212. More details and several examples of computing the pricing at 210 and updating the order at 212 for combination linksaves are described with respect to FIG. 3B, below.

Once all combination linksaves have been addressed, or in the event that no combination linksaves were present in the original order, method 200 addresses percentage linksaves at 214. Percentage linksaves correspond to items or combinations of items that are entitled to a percentage discount. In the event that at least one combination linksave was identified (e.g., by linksave identification module 114 of FIG. 1), pricing is determined for each of the linksaves at 216. Once pricing is computed, the order is updated at 218. More details and several examples of computing the pricing at 216 and updating the order at 218 for combination linksaves are described with respect to FIG. 3C, below.

Other discounts and promotions, such as for products sold by weight and quantity can be associated with other types of discounts or promotions. Other items such as those sold by weight or quantity may not be a part of any linksave, and can be added to the order without any linksave pricing (as described above with respect to module 121 of FIG. 1). Those other discounts and promotions can be applied at 220, before the final details of the fulfilled order are sent to the order total module (e.g., order total module 122 of FIG. 1).

FIG. 3A is a flowchart depicting a method 300 for pricing modification to an order that includes a multiple-item discount, and either a substitution for one or more of the multiple items has been made or some items are unavailable and have been nil picked. Method 300 corresponds to the multiples linksave 202, computation of pricing 204, and order update 206 of FIG. 2. Several examples of the handling of multiples linksaves are described in more detail below.

Data corresponding to particular items, orders, and other information is depicted below in tables. The tables could be implemented in a computer system as data objects, with each order, item, and/or item having fields for the various fields that are created, modified, or stored. Each item that is ordered by a customer can correspond to an object having fields for price, one or more linksave connections, a status indicator relating to whether the item was actually picked, substituted, and “nil picked,” among others.

At 302, a linksave is identified in a customer order. The linksave corresponds to a group of similar items that can be bought for one flat price. For example, the linksave can correspond to a discount of “buy any three As, Bs, or Cs for $15 total” or some other similar promotion. In general, the cost of the group of items is less than if they were purchased individually. The table below shows an example of a customer's order that includes six items, each of which qualifies for a “buy three for $15” promotion. The customer has ordered one of item A, four of item B, and one of item C.

Ordered

| Item | Price |
|---|---|
| A | $8 |
| B | 7 |
| B | 7 |
| B | 7 |
| B | 7 |
| C | 6 |

The total for these items would normally be $42. Because the customer has selected items A, B, and C that all qualify for the “3 for $15” promotion, however, the order total should be $30.

At 304, substituted items are identified. In one example, the retailer cannot fulfill the order for four of item B. The picker can elect to substitute these four items for a suitable substitute. In some cases, the substitution can have a larger or smaller quantity. For example, a 24-pack of an item such as soda, paper towels, or other bulk packaged goods could be a suitable substitute for four 6-packs of the same or a similar item. In this example, the substitute replaces all four of item B.

Fulfilled

| Item | Price | Comment |
|---|---|---|
| A | 8 | Picked |
| B | 20 | Substituted |
| B | | Substituted |
| B | | Substituted |
| B | | Substituted |
| C | 6 | Picked |

At 306, a “sort price” is calculated. The sort price is the effective price per unit of each item before the linksave discount. The sort price is used to sort the items from highest to lowest price. A “pick status” is also added, with “P” indicating “picked” and “S” indicating substituted. In the object-oriented implementation described above, the “pick status” field could alternatively be represented by an integer, such as 2 for picked items and 1 for substituted items.

Sort Price determination

| Item | Price | Substituted Price | Sort Price | Pick status |
|---|---|---|---|---|
| A | 8 | | 8 | P |
| B | 7 | 20 | 5 | S |
| B | 7 | | 5 | S |
| B | 7 | | 5 | S |
| B | 7 | | 5 | S |
| C | 6 | | 6 | P |

At 308, the items subject to the linksave are sorted into ranks. Sorting into ranks takes into account the pick status, in descending order from picked to substituted (and, in other embodiments as described below, nil picks can be sorted lower than substituted items). A table showing the sorted items in the example implementation is shown below. Because four of item B were substituted for one replacement item having a cost of 20, the per unit sort price for each item B is 20/4=5.

| | Sorted fulfilled items | | |
|---|---|---|---|
| Item | Price | Sort Price | Rank |
| A | 8 | 8 | 2 |
| C | 6 | 6 | 2 |
| B | 7 | 5 | 1 |
| B | 7 | 5 | 1 |
| B | 7 | 5 | 1 |
| B | 7 | 5 | 1 |

At 310, offer prices are calculated. To calculate offer prices, the items are separated into groups of three, as the original offer was “3 for $15.” In alternative embodiments where the offer was for a larger or smaller group of linked items, the items would be separated into groups corresponding to the number in the link. For example, the items would be separated into groups of four if the promotion were “4 for $15,” or groups of two if the promotion were “2 for $15.” The separation into groups is shown in the table below.

| | | Sorted fulfilled items | | |
|---|---|---|---|---|
| | Item | Price | Sort Price | Rank |
| Group 1 | A | 8 | 8 | 2 |
| | C | 6 | 6 | 2 |
| | B | 7 | 5 | 1 |
| Group 2 | B | 7 | 5 | 1 |
| | B | 7 | 5 | 1 |
| | B | 7 | 5 | 1 |

Within each grouped set, the total price should be $15. The offer price for each item within the group is:

Offer Price=Price·Linksave Price/(Sum of Prices for all members of the Group)

Thus, within Group 1, the offer prices are:

for item A, $8·15/21=$5.71;

for item C, $6·15/21=$4.29; and

for item B, $7·15/21=$5.

Within Group 2, the offer prices are all equal at $7·15/21=$5.

Offer price calculation

| | Item | Price | Sort Price | Offer Price |
|---|---|---|---|---|
| Group 1 | A | 8 | 8 | 5.71 |
| | C | 6 | 6 | 4.29 |
| | B | 7 | 5 | 5 |
| Group 2 | B | 7 | 5 | 5 |
| | B | 7 | 5 | 5 |
| | B | 7 | 5 | 5 |

At 312, prices are assigned and corresponding savings are calculated. The calculated savings can be listed with the items when they are delivered to the customer, such that a total savings amount can be seen.

Assign prices and savings

| Item | Price | Subbed Price | Offer Price | Savings |
|---|---|---|---|---|
| A | 8 | | 5.71 | 2.29 |
| C | 6 | | 4.29 | 1.71 |
| B | 7 | 20 | 20 | 0 |
| B | 7 | | | |
| B | 7 | | | |
| B | 7 | | | |

As shown in the table above, the total paid by the customer (the sum of the offer prices) is $30, as promised in the original promotion for six items in a “buy 3 for $15” category. The savings associated with each of the substituted items is $0, because the cost of the substitute was the same as the discounted cost using the linksave. Savings associated with items A and B, that were not substituted, are calculated on a prorated basis.

In a second example, the same steps can be used where a nil pick has occurred. The customer again takes advantage of a promotion of “buy any 3 As, Bs, or Cs for $15” by purchasing one A, four Bs, and one C.

Ordered

| Item | Price |
|---|---|
| A | 8 |
| B | 7 |
| B | 7 |
| B | 7 |
| B | 7 |
| C | 6 |

In this example, as described above, two linksaves are identified at 302 because six items that qualify for the linksave have been selected.

In contrast to the previous example, however, the picker may find that some items are not available and also that no suitable substitute exists. In this case, at 304 the picker can decide to “nil pick” the item that is not available and has no substitute (in this example, item C). As shown in the table below, item B is still substituted for a similar item while item C is nil picked.

Fulfilled

| Item | Price | Status |
|---|---|---|
| A | 8 | Picked |
| B | 7 | Substituted |
| B | 7 | Substituted |
| B | 7 | Substituted |
| B | 7 | Substituted |
| C | 6 | Nil Picked |

At 306, the sort price is calculated.

Calculate Sort Price

| Item | Price | Substituted Price | Sort Price | Pick Status |
|---|---|---|---|---|
| A | 8 | | 8 | P |
| B | 7 | 20 | 5 | S |
| B | 7 | | 5 | S |
| B | 7 | | 5 | S |
| B | 7 | | 5 | S |
| C | 6 | | 0 | N |

As shown in the table above, pick status “P” indicates picked items, pick status “S” indicates substituted items, and pick status “N” indicates nil picks.

At 308, the items subject to the linksave are sorted into ranks. Sorting into ranks takes into account the pick status, in descending order from picked items to substituted items to nil picks. A table showing the sorted items in the example implementation is shown below. Because four of item B were substituted for one replacement item having a cost of 20, the per unit sort price for each item B is 20/4=5. Because item C could not be fulfilled and is a nil pick, its sort price is 0 as is its rank.

| | Sorted fulfilled items | | |
|---|---|---|---|
| Item | Price | Sort Price | Rank |
| A | 8 | 8 | 2 |
| B | 7 | 5 | 1 |
| B | 7 | 5 | 1 |
| B | 7 | 5 | 1 |
| B | 7 | 5 | 1 |
| C | 6 | 0 | 0 |

At 310, offer prices are calculated. To calculate offer prices, the items are separated into groups starting at the top of the ranked list and continuing down until all sets of three eligible items have been grouped.

| | | Offer price calculation | | |
|---|---|---|---|---|
| | Item | Price | Sort Price | Offer Price |
| Group 1 | A | 8 | 8 | 5.46 |
| | B | 7 | 5 | 4.77 |
| | B | 7 | 5 | 4.77 |
| Group 2 | B | 7 | 5 | 5.25 |
| | B | 7 | 5 | 5.25 |
| | C | 6 | 0 | 0 |

The offer price for each item within the group is:

Offer Price=Price·Linksave Price/(Sum of Prices for all members of the Group)

Thus, within Group 1, the offer prices are:
for item A $8·15/22=$5.46; and
for each of item B, $7·15/22=$4.77.

Likewise, within Group 2, the offer prices are:
for each item B, $7·15/20=$5.25; and
for item C, $6·15/20=$4.50.

Because item C has been nil picked, however, the price is set to 0 so that the customer is not charged for the item that he or she did not receive. Nonetheless, a proportional discount is applied to the other items within Group 2.

At 312, prices are assigned and corresponding savings are calculated. The calculated savings can be listed with the items when they are delivered to the customer, such that a total savings amount can be seen by the customer.

In this example, the offer price for item A is $5.46, the total offer price for the substitution for the four ordered item Bs is $4.77+4.77+5.25+5.25=$20.04, and the price for item C (that was nil picked) is set to $0. In embodiments, where the offer price for a substituted item exceeds its list price, the lower of the two can be used. For example, the list price for the substitution for item B is $20.00, but the offer price calculated above is $20.04. Therefore the method 300 will only charge the customer $20.00 rather than increasing the substitution above its list price.

After this adjustment is made, the total offer price for the six ordered items is $20.00+5.46=$25.46, and the delivered items include one of item A, a substitution for the four ordered item Bs, and no item C. The total savings to the customer is $2.54 (the difference between the list price of item A, at $8, and the offer price, $5.46).

The same method 300 can be used when there is a non-multiple number of an item ordered that qualifies for a linksave. For example, a customer can order one of item A, four of item B, one of item C, all of which qualify for a promotion “buy 3 for $15.” Item D does not qualify for the “buy 3 for $15” promotion in the original order. The order at 302 is shown below, with prices for each item by way of an example.

Ordered

| Item | Price |
|---|---|
| A | 8 |
| B | 7 |
| B | 7 |
| B | 7 |
| B | 7 |
| C | 6 |
| D | 5.5 |

At 304, a picker selects the ordered items where possible, but again item B must be substituted for a suitable replacement.

Fulfilled

| Item | Price | Status |
|---|---|---|
| A | 8 | Picked |
| B | 7 | Substituted |
| B | 7 | Substituted |
| B | 7 | Substituted |
| B | 7 | Substituted |
| C | 6 | Picked |
| D | 5.5 | Picked |

At 306, the sort price is calculated, and an indicator “P” is associated with picked items and “S” is associated with substituted items. The items are arranged in descending order at 308 by the sort price. Here, the sort price of items A, C, and D is the same as the list price. The sort price of item B, however, is $5 rather than the original list price of $7, because item B has been substituted for a version having a lower price of $5 per unit or equivalent.

Sort using sort price

| Item | Price | Sort Price | Pick Status |
|---|---|---|---|
| A | 8 | 8 | P |
| C | 6 | 6 | P |
| D | 5.5 | 5.5 | P |
| B | 7 | 5 | S |
| B | 7 | 5 | S |
| B | 7 | 5 | S |
| B | 7 | 5 | S |

At 310, offer prices are calculated. Offer prices are only assigned to items that are part of a Group of three items. Item D, which was originally not part of a linksave group, is added to Group 1 when the order is fulfilled and offer prices are calculated. The offer price for each item is calculated as described above,

Offer Price=Price·Linksave Price/(Sum of Prices for all members of the Group)

Calculate offer Prices

| | Item | Price | Sort Price | Offer Price |
|---|---|---|---|---|
| Group 1 | A | 8 | 8 | 6.15 |
| | C | 6 | 6 | 4.62 |
| | D | 5.5 | 5.5 | 4.23 |
| Group 2 | B | 7 | 5 | 5 |
| | B | 7 | 5 | 5 |
| | B | 7 | 5 | 5 |
| | B | 7 | 5 | |

At 312, prices and savings are assigned or associated with each of the items. The assigned price for each item is the offer price or, where the item has been substituted, the substituted price. Savings are shown based upon the difference between the offer price and the original, retail list price.

Assign prices and savings

| Item | Price | Substituted Price | Offer Price | Savings |
|---|---|---|---|---|
| A | 8 | | 6.15 | 1.85 |
| C | 6 | | 4.62 | 1.38 |
| D | 5.5 | | 4.23 | 1.27 |
| B | 7 | 20 | 20 | 0 |
| B | 7 | | | |
| B | 7 | | | |
| B | 7 | | | |

In general, method 300 can be used to determine the offer price and amount of savings for any number of linksaves that were present at the time of an order. The method 300 can include as many Groups as the number of linksaves triggered when the order was placed, rather than the number of items that qualify for the linksave at the time of fulfillment. As such, linksaves that expire prior to fulfillment, item substitutions carried out by the picker, nil picks, and combinations thereof that might otherwise cause the loss of a promotional rate nonetheless result in an equitable discount for the purchaser based on his or her original order.

In various embodiments, method 300 can be used for orders for pick-up in store from available items in inventory, for shipments to store for later pick-up, or for online orders that are delivered directly to a customer. In some cases, these prices can vary, or there may be items that are available in-store that are not available on the general website, and vice versa. In these embodiments the list price may be different. For example, when an order is placed for a picker to select items in-store and the customer will pick them up, the list price for the item is that item's in-store price. In contrast, where the order is an online order for delivery or shipment to a local store or other facility, then the list price of the item can be the price on a retailer's website.

In embodiments, various items in an individual order can be substituted, nil picked, fulfilled as ordered, or some combination of these. As shown in FIG. 3A, a linksave can be managed in each of these scenarios by identifying the linksaves in the original customer order (302), identifying any substituted or nil-picked items (304), calculating a sort price (306), sorting the items in a descending order (308), calculating offer prices for each of the items (310), and assigning prices and savings (312) based on the difference between the list price and the offer price for each item.

FIG. 3B is a flowchart depicting a method 314 for pricing modification to an order that includes a several-item discount, and either a substitution for one or more of the multiple items has been made or some items are unavailable and have been nil picked. Whereas FIG. 3A described a method 300 of pricing multiple-item orders (e.g., buy 4 for $10, or buy 3 for $8, etc.), FIG. 3B depicts a method 314 for pricing with sets of items that are purchased together for a fixed price (e.g., buy one of X, one of Y, and one of Z for $10). For example, method 314 can correspond to identifying combinations linksaves 208, computing pricing of the combinations linksaves 210, and updating an order 212 as shown in FIG. 2.

In a first example, method 314 relates to a promotion advertising a discount of $0.50 off with any purchase of one of item A, two of item B, and two of item C. A customer places an order for three of item A, six of item B, and three of item C. That is, the customer ordered sufficient quantities to fulfill the conditions of the promotion exactly three times.

At 316, linksaves in the original customer order are identified. Because the original order as submitted qualified for the discount three times, the linksaves will be applied regardless of whether the items are substituted or nil picked prior to delivery to the customer.

In this example, each of the items could be located by the picker and no substitutions or nil picks are required. Therefore, no substituted items are identified at 318. In embodiments, identification of substituted items can be performed by a picker who elects to substitute one item from another. In other embodiments, substitutions can be selected by the picker from a predetermined set of acceptable replacement items. In some such systems, identification of substituted items can be automated, and identifying substituted items 318 can include comparing a list of acceptable substitutes to the picked items to determine whether a substitution or a nil pick has been made.

At 320, the picked items are separated into lots. Each lot corresponds to a set of items that qualify for the promotion. In this case, because there were no substitutions or nil picks, there are three lots that are identical to one another. One such lot is shown below, including prices for the items.

| Item | Unit Price |
|---|---|
| A | 13.27 |
| B | 2 |
| B | 2 |
| C | 1 |
| C | 1 |

At 322, a savings associated with each item is calculated, and offer prices are assigned to each item. According to method 314, the overall discount for each lot is prorated amongst the items in that lot. In this example, 69% of the cost of the lot is associated with item A, therefore 69% of the discount is applied to item A.

| Item | Unit Price | Offer Price | Savings |
|---|---|---|---|
| A | 13.27 | 12.93 | 0.34 |
| B | 2 | 1.95 | 0.05 |
| B | 2 | 1.95 | 0.05 |
| C | 1 | 0.97 | 0.03 |
| C | 1 | 0.97 | 0.03 |

In a second example of method 314, a promotion specifies a discount of $3 when a customer purchases one item from a first Group, two items from a second Group, and two items from a third Group, all within the same purchase. Each Group contains three items, identified by letter in the table below.

| Group 1 | Group 2 | Group 3 |
|---|---|---|
| A | B | C |
| D | E | F |
| G | H | I |

A customer orders two of item A, one of item D, and one of item G, all of which are within Group 1. In the same order, the customer also requests three of item B, two of item E, and two of item H, all of which are within Group 2. In the same order, the customer also requests two of item C, two of item F, and two of item I, all of which are within Group 3.

At 316, linksaves are identified in the customer's order. In this case, the customer has ordered enough items to fill three lots, each of which qualify for the promotion:

| | Lot 1 | Lot 2 | Lot 3 |
|---|---|---|---|
| Group 1 item | A | A | D |
| Group 2 item | B | B | E |
| Group 2 item | B | E | H |
| Group 3 item | C | F | I |
| Group 3 item | C | F | I |

Additionally, the customer has ordered one extra item in Group 1 (G) and one extra item in Group 2 (H) that fall outside of any linksave.

At 318, substituted items are identified. In this example, the picker picked only one of item A, one of item D, and one of item G. The picker also picked two of item B, two of item E, and two of item H. Finally, the picker picked two of item C, two of item F, and two of item I. In this case, although two items were not picked, the picker did not make any substitutions.

At 320, the picked or fulfilled items are sorted into lots.

Fulfilled order

| | Lot 1 | Lot 2 | Lot 3 |
|---|---|---|---|
| Group 1 item | A | D | G |
| Group 2 item | B | E | H |
| Group 2 item | B | E | H |
| Group 3 item | C | F | I |
| Group 3 item | C | F | I |

Two items (one of item A and one of item B) were nil picked by the picker. Items G and H that were not a part of any linksave at 316 fill in to complete the linksaves at 318, as shown in the table above.

Using conventional pricing models, the customer would only have been entitled to one discount, because two of the original lots were “broken” during fulfillment. However, because items G and H can be effectively substituted for the missing items from each of those two linksaves, the customer will retain all three discounts.

At 322, savings and offer prices are calculated. As described above, the overall discount for each lot is prorated amongst the items within each lot. Example prices and discounts are shown in the table below.

Lot 1 offer price and savings

| Item | Unit Price | Offer Price | Savings |
|---|---|---|---|
| A | 10 | 9.22 | 0.78 |
| B | 8.08 | 7.45 | 0.63 |
| B | 8.08 | 7.45 | 0.63 |
| C | 6.21 | 5.73 | 0.48 |
| C | 6.21 | 5.73 | 0.48 |

Lot 2 offer price and savings

| Item | Unit Price | Offer Price | Savings |
|---|---|---|---|
| D | 8.98 | 8.18 | 0.80 |
| E | 7.12 | 6.49 | 0.63 |
| E | 7.12 | 6.49 | 0.63 |
| F | 5.21 | 4.75 | 0.46 |
| F | 5.21 | 4.75 | 0.46 |

Lot 3 offer price and savings

| Item | Unit Price | Offer Price | Savings |
|---|---|---|---|
| G | 7.98 | 7.48 | 0.50 |
| H | 7.01 | 6.57 | 0.44 |
| H | 7.01 | 6.57 | 0.44 |
| I | 5.01 | 4.70 | 0.31 |
| I | 5.01 | 3.70 | 1.31 |

In embodiments, the same item can make up a part of multiple linksaves. In those multiple linksaves, depending on the prices of other items within the lot, the discount associated with the particular item can vary. This is because the prorated amount of the discount is dependent upon the total price of all of the items within the lot.

In a third example of method 314, items are both nil picked and substituted. In this example, the promotion offers a discount of $3 for buying one of item A, two of item B, and two of item C. A customer orders three of item A at $13.27 per item, six of item B at $2 per item, and six of item C at $1.28 per item, and therefore there are three linksaves in the customer's order at 316 because the customer qualifies for the promotion three times over.

| Item | Quantity ordered | Price |
|---|---|---|
| A | 3 | 13.27 |
| B | 6 | 2 |
| C | 6 | 1.28 |

At 318, the picker selects three of item A, exactly as ordered. However, the picker selects only two of item B and substitutes two of item B1 for the other four orders of item B. The cost of item B1 is $2 per item. The picker also substitutes two of item C1 for two of the ordered item C, and nil picks two of the ordered item C. The cost of C1 is $1.98 per item.

At 320, the picked items are separated into lots, each lot containing a set of items that would have satisfied the promotion at the time of ordering. The three lots are shown below:

Lot 1

| Ordered item | Ordered item price | Fulfilled item | Fulfilled item price |
|---|---|---|---|
| A | 13.27 | A | 13.27 |
| B | 2 | B | 2 |
| B | 2 | B | 2 |
| C | 1.28 | C1 | 0.97 |
| C | 1.28 | C1 | 0.97 |

Lot 2

| Ordered item | Ordered item price | Fulfilled item | Fulfilled item price |
|---|---|---|---|
| A | 13.27 | A | 13.27 |
| B | 2 | B1 | 1 |
| B | 2 | B1 | 1 |
| C | 1.28 | C1 | 0.97 |
| C | 1.28 | C1 | 0.97 |

Lot 3

| Ordered item | Ordered item price | Fulfilled item | Fulfilled item price |
|---|---|---|---|
| A | 13.27 | A | 13.27 |
| B | 2 | B1 | 1 |
| B | 2 | B1 | 1 |
| C | 1.28 | nil pick | 0 |
| C | 1.28 | nil pick | 0 |

Lot 3 remains as a linksave because it was identified at 316, even though the fulfilled order does not contain enough items to completely satisfy the terms of the promotion.

Savings are calculated and prices assigned at 322 exactly as described in the previous example. That is, the discount is prorated among the items based upon the price of the fulfilled item. Nil picked items, because their price is zero, do not receive any discount amount.

Lot 1

| | Ordered | Fulfilled | Fulfilled | | Offer |
|---|---|---|---|---|---|
| Ordered item | item price | item | item price | Discount | price |
| A | 13.27 | A | 13.27 | 2.07 | 11.20 |
| B | 2 | B | 2 | 0.31 | 1.69 |
| B | 2 | B | 2 | 0.31 | 1.69 |
| C | 1.28 | C1 | 0.97 | 0.15 | 0.82 |
| C | 1.28 | C1 | 0.97 | 0.15 | 0.82 |

Lot 2

| | Ordered | Fulfilled | Fulfilled | | Offer |
|---|---|---|---|---|---|
| Ordered item | item price | item | item price | Discount | price |
| A | 13.27 | A | 13.27 | 2.31 | 10.96 |
| B | 2 | B1 | 1 | 0.17 | 0.83 |
| B | 2 | B1 | 1 | 0.17 | 0.83 |
| C | 1.28 | C1 | 0.97 | 0.17 | 0.80 |
| C | 1.28 | C1 | 0.97 | 0.17 | 0.80 |

Lot 3

| | Ordered | Fulfilled | Fulfilled | | Offer |
|---|---|---|---|---|---|
| Ordered item | item price | item | item price | Discount | price |
| A | 13.27 | A | 13.27 | 2.23 | 11.04 |
| B | 2 | B1 | 1 | 0.11 | 0.9 |
| B | 2 | B1 | 1 | 0.11 | 0.9 |
| C | 1.28 | nil pick | 1.28 | 0.14 | 1.14 |
| C | 1.28 | nil pick | 1.28 | 0.40 | 0.88 |

Various combinations of substitutions, nil picks, and fulfilled items can be handled by method 314 for pricing promotions on combinations of items. Nil picked items are not considered when calculating final savings for a customer's order.

In embodiments, method 314 can be carried out for promotions that require varying numbers of items in combination to receive a particular discount. In the example above, three items A, B, and C were required to receive a discount. In alternative embodiments, it will be understood that the number of items that are combined to receive the discount can be four, five, or even higher numbers of distinct items.

In embodiments, a retailer can offer many different combination promotions. In that case, it is often preferable to check for linksaves that require the largest number of items in combination first. After items are associated with those combinations in linksaves, then the remaining items can be checked to determine whether any other, smaller combinations are present. For example, at linksave identification 114 of FIG. 1, linksaves can be associated with an item order in descending order of complexity (e.g., 5-item lots, then 4-item lots, then 3-item lots, then 2-item lots).

Likewise, in embodiments combinations linksaves 208 of FIG. 2 can be performed in a loop until all combinations linksaves have been completed. The first iterations of the loop can compute prices and discounts for more complex linksaves, and the remaining items can then be associated with the other, smaller combinations.

FIG. 3C is a flowchart depicting a method 324 for pricing modification to an order that includes a percentage-based discount. In embodiments, a substitution for one or more of the items within the percentage-based discount has been made, or some of the items subject to a percentage-based discount have been nil picked. Method 324 can correspond to identifying percentage-based linksaves 214, computing pricing of the combinations linksaves 216, and updating an order 218 as shown in FIG. 2.

At 326, linksaves in the original customer order are identified. The identified linksaves can be, for example, “buy two save 20%” or similar percentage-based discounts or promotions.

At 328, substituted items are identified. Even though the original promotion may have specified a particular brand or size of item, if a substitution has been made by a picker then the substituted item will still qualify for the discount or promotion.

At 330, all of the items eligible for the promotion, either because they were picked or because they were substituted for qualifying items, are sorted into groups. In the example above, “buy two save 20%,” the groups each consist of two items. Those two items can be picked items, or they can be a picked item and a substituted item.

If a substituted item replaces multiple qualifying items from the original order, a substitution can be associated with multiple ones of the original order items in the sorted groups. For example, if a 12-pack of a particular item is substituted for two 6-packs of the same item, then the 12-pack will be associated with two separate items from the original order. In that case, the 20% discount would apply to the 12-pack, which forms its own group corresponding to two of the originally-ordered items. Similarly, if multiple substituted items replace a qualifying item from the original order, the group can associate multiple substituted items with one of the originally-ordered items.

In another example a linksave is identified at 326 that can provide a discount of $0.90 when three of any of items A, B, or C are purchased. A customer orders five of item A, four of item B, and two of item C. Item A has a price of $4, item B has a price of $3.82, and item C has a price of $1.70 in this example. A summary of the customer's order is shown in the table below.

| Item | Price |
|---|---|
| A | 4 |
| A | 4 |
| A | 4 |
| A | 4 |
| A | 4 |
| B | 3.82 |
| B | 3.82 |
| B | 3.82 |
| B | 3.82 |
| C | 1.7 |
| C | 1.7 |

At 328, substituted items and nil picked items are identified. In this example, the picker was unable to find any of item A. Two of item A are nil picked, while the other three of the original order of A are substituted for an equivalent item. The substitute, equivalent item has a price of $3.80.

Fulfilled order

| Item | Price | Status | Substitute price |
|---|---|---|---|
| A | 4 | Picked | |
| A | 4 | Subbed | 3.8 |
| A | 4 | Subbed | 3.8 |
| A | 4 | Nill Picked | |
| A | 4 | Nill Picked | |
| B | 3.82 | Picked | |
| B | 3.82 | Picked | |
| B | 3.82 | Picked | |
| B | 3.82 | Picked | |
| C | 1.7 | Picked | |
| C | 1.7 | Picked | |

At 330, a sort price is calculated for each item, and the items are sorted based on their picked status (first fulfilled, then substituted, then nil picks). Within each of these, the fulfilled items are sorted in descending order of price.

| Item | Price | Sort Price | Pick Status |
|---|---|---|---|
| A | 4 | 4 | P |
| B | 3.82 | 3.82 | P |
| B | 3.82 | 3.82 | P |
| B | 3.82 | 3.82 | P |
| B | 3.82 | 3.82 | P |
| A | 4 | 3.8 | S |
| A | 4 | 3.8 | S |
| C | 1.7 | 1.7 | P |
| C | 1.7 | 1.7 | P |
| A | 4 | 0 | N |
| A | 4 | 0 | N |

The resulting list of fulfilled items (and nil picks) is then separated into groups of three, because the original promotion specified a discount for each set of three items.

| | Item | Price | Sort Price | Pick Status |
|---|---|---|---|---|
| Group 1 | A | 4 | 4 | P |
| | B | 3.82 | 3.82 | P |
| | B | 3.82 | 3.82 | P |
| Group 2 | B | 3.82 | 3.82 | P |
| | B | 3.82 | 3.82 | P |
| | A | 4 | 3.8 | S |
| Group 3 | A | 4 | 3.8 | S |
| | C | 1.7 | 1.7 | P |
| | C | 1.7 | 1.7 | P |
| | A | 4 | 0 | N |
| | A | 4 | 0 | N |

Other linksaves and discounts can be applied in a similar fashion to those described above. For example, discounts or promotions can be offered by a retailer that are based upon a non-discrete product. For example, a discount may apply for a dollar-amount or percentage off of any quantity of an item in excess of a certain weight (e.g., $1 off any order of 2 pounds or more of apples). As described above, items can be sorted based on their status (picked, substituted, nil picked) and assigned a sort price. Based on the sort price and the substitutions and nil picks, the discount can be applied amongst the remaining items.

Embodiments described herein can be implemented in systems of handheld picking tools, databases, and physical storage sites for the items to be shipped. In some embodiments conventional systems for picking, storage, and data collection and monitoring can be used, but the implementation is carried out using the linksave methods above. This unique method of using such apparatuses, when viewed as a whole, applies a linksave-based system to perform several functions, including processes for pricing and/or preparing shipments to a customer.

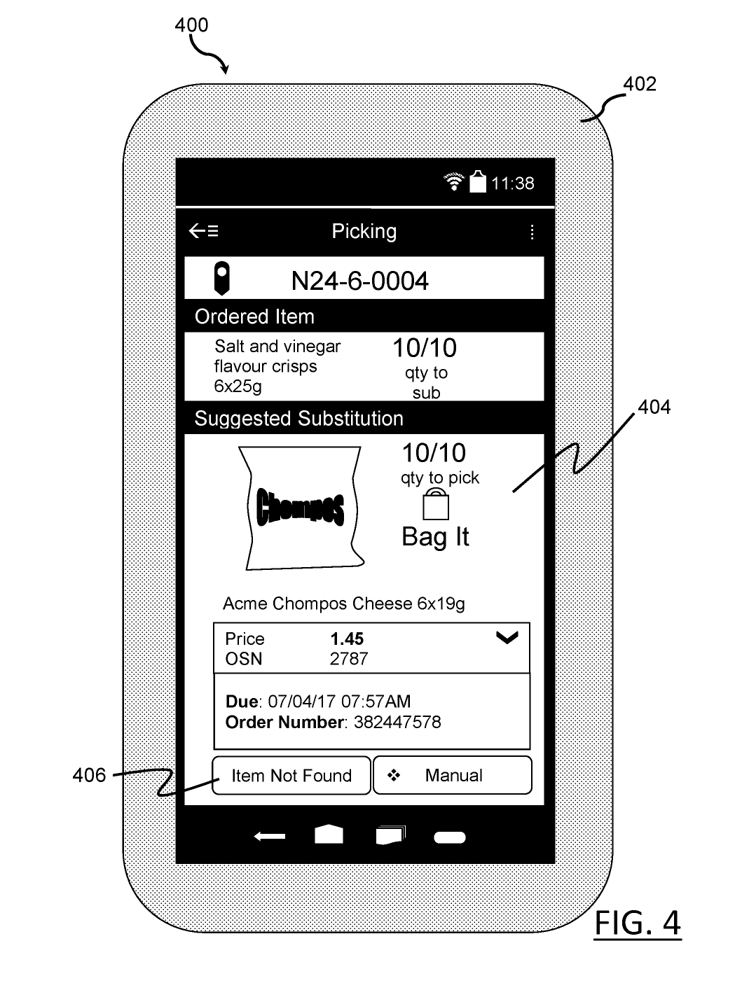

One example of a handheld picking tool is shown in FIG. 4. Tool 400 shown in FIG. 4 includes a housing 402 having a display 404. Display 404 can indicate an item that a picker is responsible for acquiring to fulfill an order. Display 404 also includes a button 406 for “Item not found.” The picker can indicate, using this button, that a substitution or nil pick will be made. In the embodiment shown in FIG. 4, button 406 is a touch-screen button. In alternative embodiments, button 406 could be a physical button, or an item can be substituted simply by scanning a replacement item. Various alternatives to tool 400 can be used by pickers as described above with respect to FIG. 1, including physical buttons, touchscreens, barcode scanners, and other features that enable the picker to send and receive necessary information to the picking management system (e.g., picking management system 104) to fulfill orders.

In embodiments, the systems described herein and/or their components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application-specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities can be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed embodiments. It should be appreciated, moreover, that the various features of the embodiments that have been described can be combined in various ways to produce numerous additional embodiments. Moreover, while various materials, dimensions, shapes, configurations and locations, etc. have been described for use with disclosed embodiments, others besides those disclosed can be used without exceeding the scope of the claimed embodiments.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A system for pricing a set of items for shipment to a customer, the system comprising:
an ordering interface configured to receive an order for the set of items from the customer;
a fulfillment device configured to:
receive the order for the set of items from the ordering interface,
monitor a fulfilled set of items that are selected for shipment to the customer, and
release the fulfilled set of items for shipment to the customer; and
an analytical engine communicatively coupled with the fulfillment device to calculate a price for the fulfilled set of items and communicate the price for the fulfilled set of items to the fulfillment device, the analytical engine comprising:
an item comparison module configured to compare the set of items with an inventory of discounts and promotions to generate linksaves;
a replacement identification module configured to compare the set of items with the fulfilled set of items to determine a quantity of nil picks and a quantity of substitutions for each item of the set of items,
a categorization module configured to categorize the linksaves and associate each of the fulfilled set of items, the nil picks, and the substitutions with a corresponding linksave;
a plurality of linksave modules each associated with a category of linksave, each of the linksave modules configured to calculate a subtotal price and savings for each of the fulfilled set of items, and
a summing module configured to receive the subtotal prices and savings for each of the fulfilled set of items and generate the price for the fulfilled set of items.

2. The system of claim 1, wherein the discounts include:
at least some of the fulfilled set of items being multiples of a same item at a bulk price;
at least some of the fulfilled set of items being multiples of a same item at a bulk price, and others of the fulfilled set of items being substitutes for the same item;
at least some of the fulfilled set of items being a grouping of multiple items at a grouped price;
at least some of the fulfilled set of items being assigned a percent discount; and
at least some of the fulfilled set of items being multiples of a same item associated with a flat discount amount.

3. The system of claim 2, wherein the analytical engine is configured to apply the discounts in the following order:
at least some of the fulfilled set of items being multiples of a same item at a bulk price; then
at least some of the fulfilled set of items being multiples of a same item at a bulk price, and others of the fulfilled set of items being substitutes for the same item; then
at least some of the fulfilled set of items being a grouping of multiple items at a grouped price; then
at least some of the fulfilled set of items being assigned a percent discount; and then
at least some of the fulfilled set of items being multiples of a same item associated with a flat discount amount.

4. The system of claim 1, further comprising a module for pricing non-discrete items.

5. The system of claim 1, further comprising a tax module configured to apply a tax to the price produced by the analytical engine.

6. The system of claim 1, further comprising a linksave identification module configured to compare the fulfilled set of items to the ordered set of items and generate a list of linksaves that were applicable at the time when the order was placed at the ordering interface.

7. The system of claim 6, wherein the system is configured to apply any linksaves that were applicable at the time the order was placed in order to determine the price despite an indication from the fulfillment device of a substitution or a nil pick.

8. The system of claim 1, further comprising a point of sale communicatively coupled to the analytical engine and the fulfillment device and configured to:
receive the price of the fulfilled set of items from the analytical engine;
receive a payment for the price of the fulfilled set of items from the customer; and
instruct the fulfillment device to release the fulfilled set of items for delivery to the customer.

9. A method comprising:
acquiring an order for a set of items from a customer via an ordering interface;
sending the order from the ordering interface to a fulfillment device;
fulfilling the order using the fulfillment device and tracking a fulfilled set of items that are selected for shipment to the customer; and
calculating, at an analytical engine, a price for the fulfilled set of items, the analytical engine comprising:
a comparator module configured to compare the set of items with the fulfilled set of items,
a counter module configured to determine a quantity of nil picks and a quantity of substitutions for each of the set of items,
a plurality of linksave modules each associated with one of a corresponding plurality of discount types and configured to calculate a subtotal price and savings for each of the fulfilled set of items, and
a summing module configured to receive the subtotal prices and savings for each of the fulfilled set of items and generate the price for the fulfilled set of items.

10. The method of claim 9, further comprising replacing one of the set of items with a substitution, wherein the substitution is selected from a similar item or a nil pick.

11. The method of claim 10, further comprising sending an indication of the substitution or the nil pick from the fulfillment device to the analytical engine.

12. The method of claim 9, wherein the discounts include:
at least some of the fulfilled set of items being multiples of a same item at a bulk price;
at least some of the fulfilled set of items being multiples of a same item at a bulk price, and others of the fulfilled set of items being substitutes for the same item;
at least some of the fulfilled set of items being a grouping of multiple items at a grouped price;
at least some of the fulfilled set of items being assigned a percent discount; and
at least some of the fulfilled set of items being multiples of a same item associated with a flat discount amount.

13. The method of claim 12, wherein the analytical engine is configured to apply the discounts in the following order:
at least some of the fulfilled set of items being multiples of a same item at a bulk price; then
at least some of the fulfilled set of items being multiples of a same item at a bulk price, and others of the fulfilled set of items being substitutes for the same item; then
at least some of the fulfilled set of items being a grouping of multiple items at a grouped price; then
at least some of the fulfilled set of items being assigned a percent discount; and then
at least some of the fulfilled set of items being multiples of a same item associated with a flat discount amount.

14. The method of claim 9, further comprising determining at the analytical engine a price of non-discrete items.

15. The method of claim 9, further comprising applying a tax to the price produced by the analytical engine via a tax module.

16. The method of claim 9, further comprising comparing the fulfilled set of items to the ordered set of items and generating a list of linksaves that were applicable at the time when the order was placed at the ordering interface.

17. The method of claim 9, further comprising applying any linksaves that were applicable at the time the order was placed in order to determine the price despite an indication from the fulfillment device of a substitution or a nil pick.
